(19) United States
(12) Patent Application Publication
(10) Pub. No.: US 2020/0172016 A1
(43) Pub. Date: Jun. 4, 2020

(54) MULTIFUNCTIONAL CARGO SLING/SHELF

(71) Applicant: GM Global Technology Operations LLC, Detroit, MI (US)

(72) Inventors: Victor K. Sanders, Waterford, MI (US); Jordan D. Guelde, Rochester Hills, MI (US); Raymond L. Wojdacki, JR., Rochester, MI (US); Brian V . Williamson, Brownstown, MI (US)

(21) Appl. No.: 16/206,239

(22) Filed: Nov. 30, 2018

(51) Int. Cl. B60R 5/04

(52) U.S. Cl. CPC B60R 5/047

(57) ABSTRACT

A cargo sling and shelf for a vehicle includes a first rail positioned in an interior of a rear cargo space of the motor vehicle, the first rail having a plurality of slots; a second rail positioned on an opposite side of the interior of the rear cargo space, the second rail having a plurality of slots, the second rail being substantial parallel to the first rail; a first crossbar having a first end that engages with one of the plurality of slots of the first rail and a second end that engages with one of the plurality of slots of the second rail; a second crossbar having a first end that engages with one of the plurality of slots of the first rail and a second end that engages with one of the plurality of slots of the second rail; and a mesh having a first side that is attached to the first crossbar and a second side that is attached to the second crossbar. The mesh forms a shelf between the first crossbar and the second crossbar.

### INTRODUCTION

The present disclosure relates to a cover for a rear cargo space for a vehicle. More specifically, the present disclosure relates to a multifunctional cargo sling and shelf.

In many vehicles, a cargo space exists in the rear of the vehicle, for example, behind the back seat. For the sake of privacy, a cover is typically pulled over the items placed and stored in the cargo space. The cover, however, is typically not configurable other than to be fully extend over the cargo space. Further, the covers are not typically not configured for placement of items on top of the cover.

Thus, while current rear cargo space covers achieve their intended purpose, there is a need for a new and improved system and method for covering and transporting items placed in the rear cargo space of vehicles.

### SUMMARY

According to several aspects, a cargo sling and shelf for a vehicle includes a first rail positioned in an interior of a rear cargo space of the motor vehicle, the first rail having a plurality of slots; a second rail positioned on an opposite side of the interior of the rear cargo space, the second rail having a plurality of slots, the second rail being substantial parallel to the first rail; a first crossbar having a first end that engages with one of the plurality of slots of the first rail and a second end that engages with one of the plurality of slots of the second rail; a second crossbar having a first end that engages with one of the plurality of slots of the first rail and a second end that engages with one of the plurality of slots of the second rail; and a mesh having a first side that is attached to the first crossbar and a second side that is attached to the second crossbar. The mesh forms a shelf between the first crossbar and the second crossbar.

In an additional aspect of the present disclosure, the mesh forms a sling between the first crossbar and the second crossbar.

In another aspect of the present disclosure, the mesh is partially rolled about the first crossbar or the second crossbar to form a reduced shelf.

In another aspect of the present disclosure, the mesh includes one or more storage pockets.

In another aspect of the present disclosure, at least one of the storage pockets is a zippered storage pocket.

In another aspect of the present disclosure, the mesh includes raised edges to prevent items from rolling off the mesh.

In another aspect of the present disclosure, the edges are made of rubber.

In another aspect of the present disclosure, the cargo sling and shelf further includes a first mounting bracket positioned below the first rail in the interior of the rear cargo space and a second mounting bracket positioned below the second rail in the interior of the rear cargo space, the first end of the first crossbar engaging with the first mounting bracket and the second end of the first crossbar engaging with the second mounting bracket.

In another aspect of the present disclosure, the sling and shelf holds about 40 kg.

In another aspect of the present disclosure, the plurality of slots of the first rail is five slots and the plurality of slots of the second rail is five slots.

According to several aspects, a method of forming a cargo sling and shelf in a motor vehicle includes one or more of the following: positioning a first end of a first crossbar in one of a plurality of slots in a first rail and a second end the first crossbar in of one a plurality of slots in a second rail, the first rail being positioned in an interior of a rear cargo space of the motor vehicle; and positioning a first end of a second crossbar in one of the plurality of slots in the first rail and a second end the second crossbar in of one the plurality of slots in the second rail, the second rail positioned on an opposite side of the interior of the rear cargo space, the second rail being substantial parallel to the first rail. The mesh has a first side is attached to the first crossbar and a second side that is attached to the second crossbar, the mesh forming a shelf between the first crossbar and the second crossbar.

In another aspect of the present disclosure, the mesh forms a sling between the first crossbar and the second crossbar.

In another aspect of the present disclosure, the method further includes partially rolling the mesh about the first crossbar or the second crossbar to form a reduced shelf.

In another aspect of the present disclosure, the mesh includes one or more storage pockets.

In another aspect of the present disclosure, at least one of the storage pockets is a zippered storage pocket.

In another aspect of the present disclosure, the mesh includes raised edges to prevent items from rolling off the mesh.

In another aspect of the present disclosure, the method further includes positioning the first end of the first crossbar in a first mounting bracket and the second end of the first crossbar in a second mounting bracket, the first mounting bracket being positioned below the first rail in the interior of the rear cargo space and the second mounting bracket being positioned below the second rail in the interior of the rear cargo space.

In another aspect of the present disclosure, the sling and shelf holds about 40 kg.

According to several aspects, a cargo sling and shelf for a vehicle includes a first rail positioned in an interior of a rear cargo space of the motor vehicle, the first rail having a plurality of slots; a second rail positioned on an opposite side of the interior of the rear cargo space, the second rail having a plurality of slots, the second rail being substantial parallel to the first rail; a first mounting bracket positioned below the first rail in the interior of the rear cargo space and a second mounting bracket positioned below the second rail in the interior of the rear cargo space; a first crossbar having a first end that engages with one of the plurality of slots of the first rail or the first mounting bracket and a second end that engages with one of the plurality of slots of the second rail or the second mounting bracket; a second crossbar having a first end that engages with one of the plurality of slots of the first rail and a second end that engages with one of the plurality of slots of the second rail; and a mesh having a first side that is attached to the first crossbar and a second side that is attached to the second crossbar. The mesh forms a shelf or a sling between the first crossbar and the second crossbar.

In another aspect of the present disclosure, the mesh is partially rolled about the first crossbar or the second crossbar to form a reduced shelf.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a cargo sling and shelf according to an exemplary embodiment;

FIG. 2 shows the cargo sling and shelf partially rolled up;

FIG. 3 shows multiple positions of a crossbar of the cargo sling and shelf;

FIG. 4 shows the cargo sling and shelf in one of a multiple sling positions;

FIG. 5 shows the cargo sling and shelf in another sling position;

FIGS. 6A and 6B show the cargo sling and shelf in multiple sling positions;

FIG. 7 shows the cargo sling and shelf with a first side in a lowered position;

FIG. 8 shows a side view of the sling shown in FIG. 7;

FIG. 9 shows an edge of a mesh of the cargo sling and shelf;

FIG. 10 shows a set of pockets on the mesh;

FIG. 11A is a close-up view of one of a pair of rails of the cargo sling and shelf;

FIG. 11B is a perspective view of an end of a crossbar of the cargo sling and shelf engaged with one of the pair of rails;

FIG. 12 is a side view of an end of a crossbar of the cargo sling and shelf engaged with one of the pair of rails; and

FIG. 13 shows a set of steps of utilize the cargo sling and shelf according to an exemplary embodiment.

### DETAILED DESCRIPTION

The following description is merely exemplary in nature and is not intended to limit the present disclosure, application, or uses.

Referring to FIG. 1, there is shown a cargo sling and shelf 10 for a vehicle 12 in accordance with the principles of the present disclosure. The cargo sling and shelf 10 is positioned in a rear cargo space 15 of the vehicle 12, for example, behind a backseat 14.

The cargo sling and shelf 10 includes a cargo net or mesh 16, a first crossbar 18, a second crossbar 20, a first rail 22 and a second rail 24. The first rail 22 and the second rail 24 are space apart and attached to opposite sides of the rear cargo space 14, for example, to interior side panels with any suitable attachment mechanism, such as, rivets, screws or glue. The first rail 22 and the second rail 24 are generally parallel to each other as well as to the bottom of the rear cargo space 15. Two of the outer sides of the mesh 16 are attached to the first crossbar 18 and the second crossbar 20 as shown in FIG. 1. The sides of the mesh 16 are attached to the crossbars 18 and 20 with rivets, screws or glue. Alternatively, each side includes a sleeve in which the crossbar 18 or 20 slides into. The crossbars 18 and 20 and the rails 22 and 24 are made of any suitable material, such as, for example, plastic, composites or metal. The mesh 16 is made of any suitable flexible material and is washable in particular arrangements.

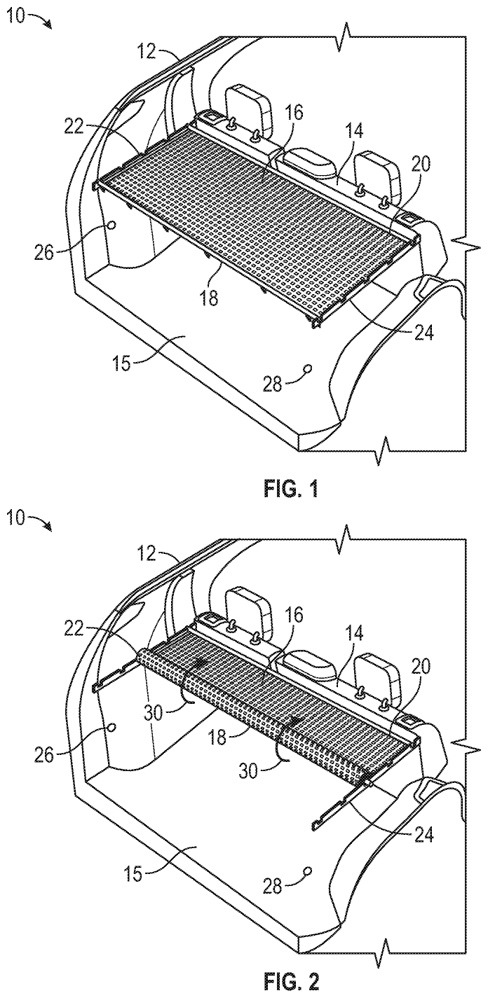

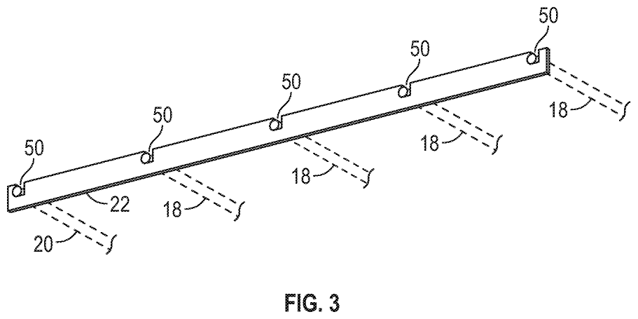

Referring to FIG. 3, the first rail 22 includes has a set of slots 50 spaced along the length of the first rail 22. The second rail 24 has a set of slots 50 spaced along the second rail 24 as well. With the second crossbar 20 positioned as shown, the first crossbar 18 is positioned in any of the remaining slots 50 of the rails 22 and 24. As such, when the first crossbar 18 is positioned in the slots 50 of the rails 22 and 24 furthest from the second crossbar 20, that is, the first crossbar 18 and the second crossbar 20 are positioned in the outermost slots 50, the mesh 16 is stretched out to form a shelf that fully covers the rear cargo space 15 as shown in FIG. 1. In other arrangements, the mesh 16 is rolled about the first crossbar 18, as indicated by the arrows 30, with the first crossbar 18 positioned in the slots 50 of the rails 22 and 24 closer to second crossbar 20 to form a reduce shelf, as shown in FIG. 2. In particular arrangements, the second crossbar 20 is positioned in the inner slots 50 of the rails 22 and 24, such that, mesh 16 forms a reduced shelf in any desired location along the rails 22 and 24. As described below, each of the slots 50 in the first rail 22 and the second rail 24 has a generally square or rectangular shape. Further, each of the crossbars 18 and 20 have a generally square or rectangular cross section sized to fit within the slots 50. Accordingly, when the crossbars 18 and 20 are placed in their respective slots 50, the crossbars 18 and 20 do not spin within the slots 50.

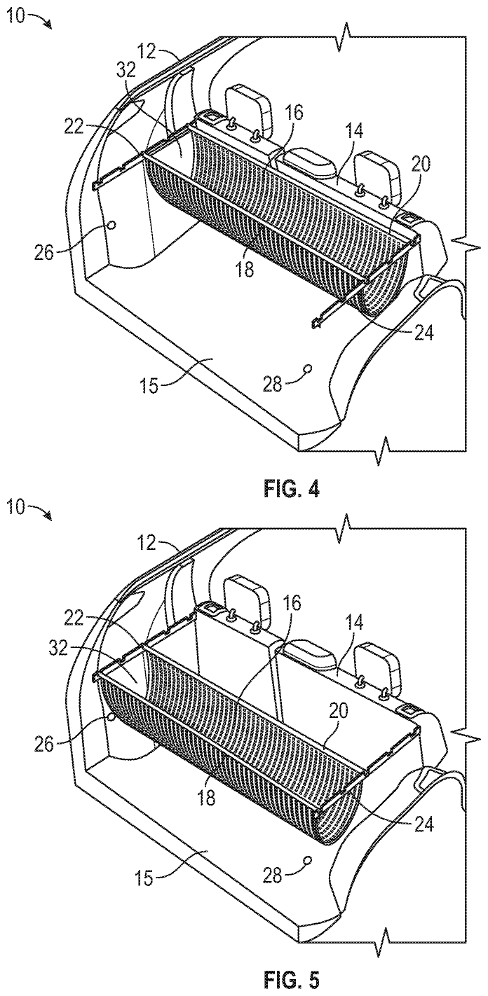

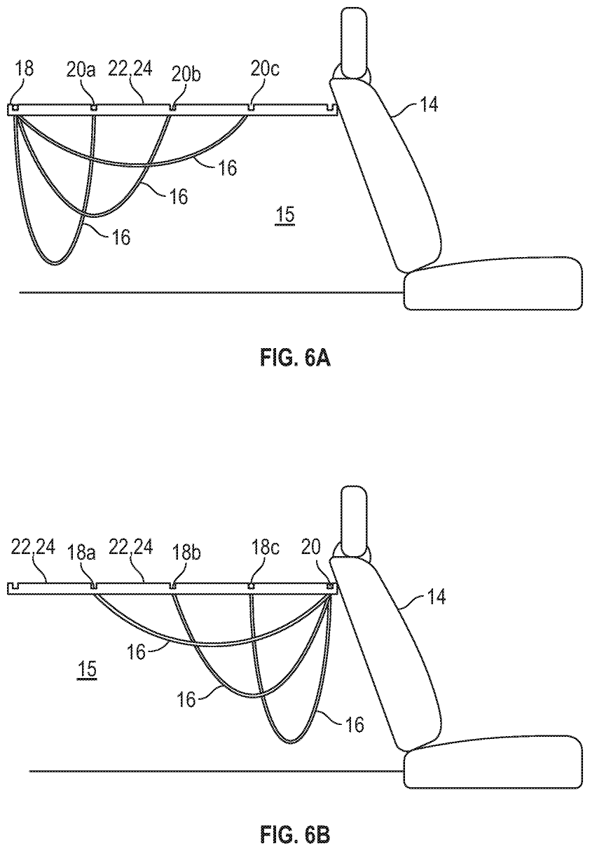

Referring now to FIGS. 4 and 5, the crossbars 18 and 20 are positioned along the rails 22 and 24 to form a sling 32 rather than a shelf shown in FIGS. 1 and 2. For example, in FIG. 4, the second crossbar 20 is positioned adjacent to the backseat 14, while the first crossbar 18 is positioned along the rails 22 and 24 to form the sling 32. Specifically, as shown in FIG. 6B, the crossbar 18 is positioned in any of the inner slots 50 such that the mesh 16 droops down into one of multiple positions in the rear cargo space 15. The alternatively positions for the crossbar 18 are identified as 18a, 18b and 18c. Note that the second crossbar 20 is positioned in one of the inner set of slots 50 of the rails 22 and 24 in certain arrangements such that the sling 32 is positioned inwardly from the outer most slots 50 of the rails 22 and 24.

Turning to FIGS. 5 and 6A, the first crossbar 18 is positioned in the rearmost slots 50 of the rails 22 and 24, while the second crossbar 20 is positioned, as indicated by 20a, 20b and 20c, in the various inner slots 50 such that the mesh 16 droops down into one of multiple positions in the rear cargo space 15 as clearly shown in FIG. 6A.

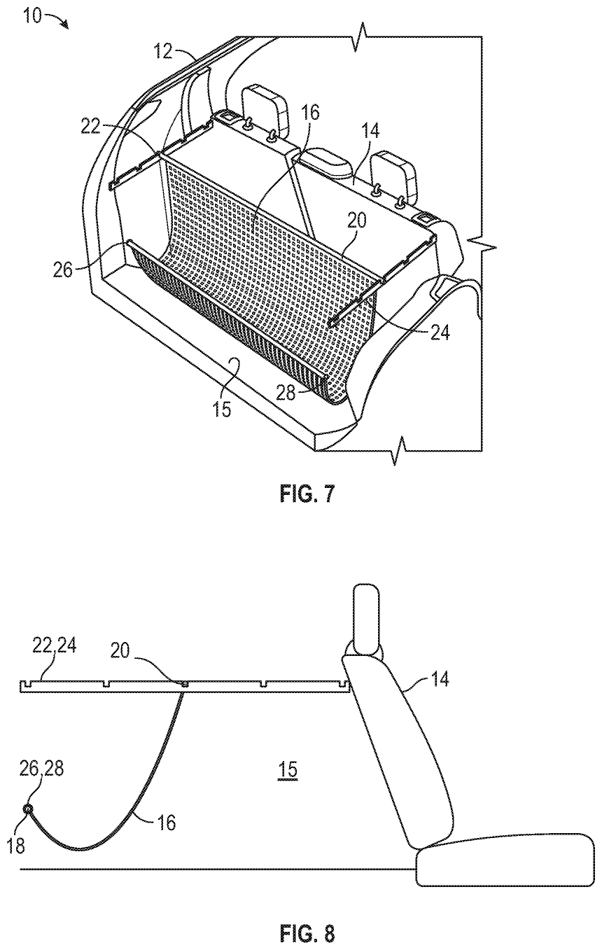

Referring now to FIGS. 7 and 8, the cargo sling and shelf 10 includes a set of lower mounting brackets 26 and 28 in various arrangements. As such, the first crossbar 18 is placed in the lower mounting brackets 26 and 28 while the second crossbar 20 is placed in any of the of the slots 50 along the rails 22 and 24 to form the sling shown in FIGS. 7 and 8.

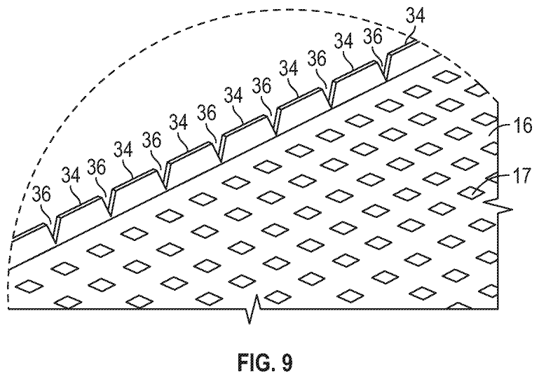

Turning to FIG. 9, the mesh 16 includes a plurality of openings 17 in some arrangements, while in other arrangements, the mesh 16 is a solid piece of material. In various arrangements, each of the sides of the mesh 16 generally perpendicular to the sides attached to the crossbars 18 and 20 include a set of raised edges 34 to prevent objects from rolling off the shelf formed between the crossbars 18 and 20. A slot 36 is positioned between adjacent edges 34 to enable the mesh 16 to be rolled about either crossbar 18 and 20.

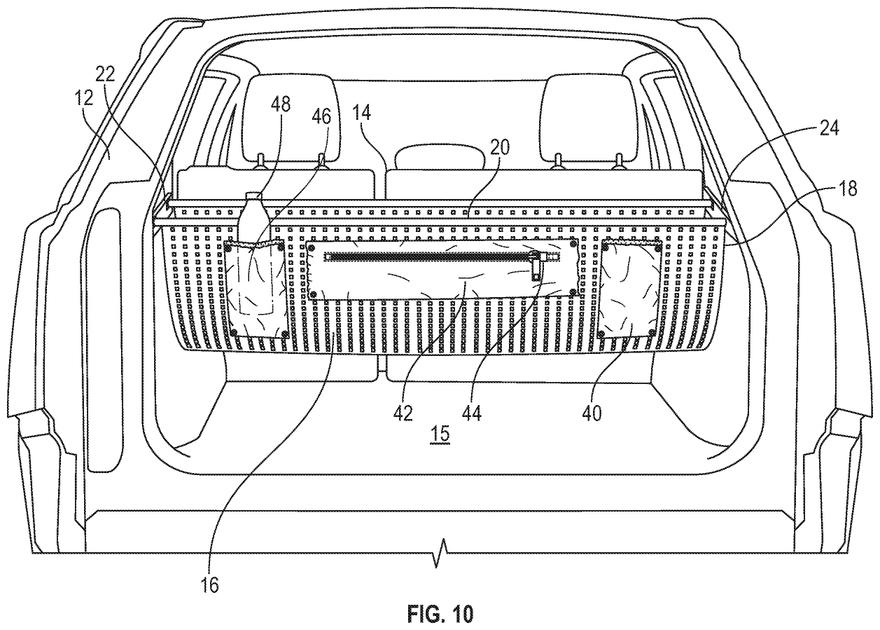

Referring now to FIG. 10, the mesh 16, in particular arrangements, includes a set of pockets 40, 42 and 46 for the storage of various items. For example, a water bottle 48 can be placed in the pocket 46. In some arrangements, a pocket, such as the pocket 42, includes a zipper 44 to secure certain items within the pocket. One or more of the pockets are translucent in some arrangements to enable one to see the contents in the pocket. In particular arrangements, hooks are placed on either crossbar 18 and 20 to enable hanging items from the respective crossbar

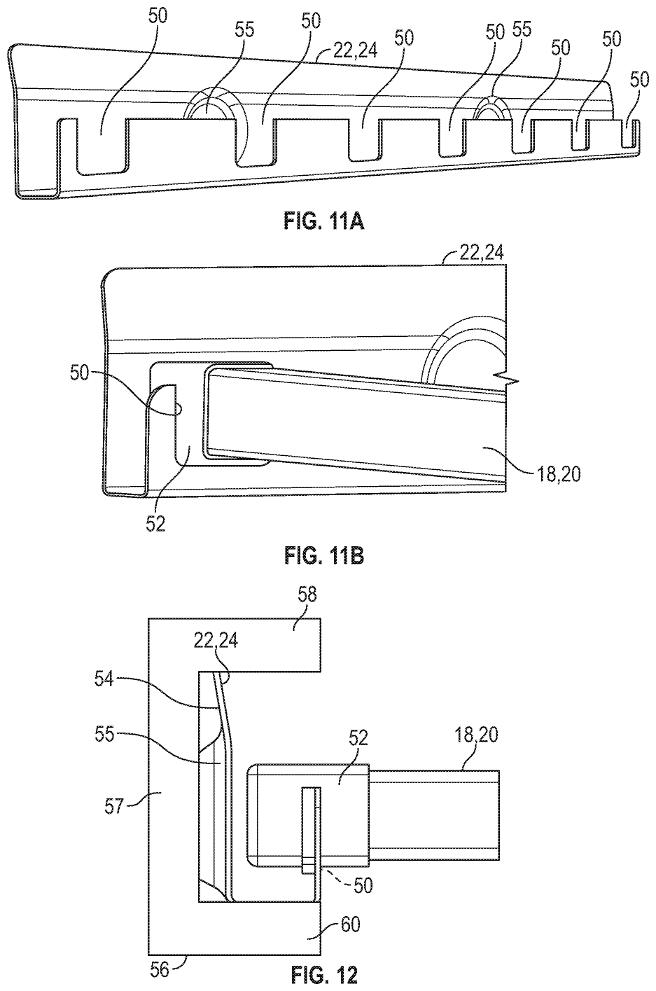

Turning now to FIGS. 11A, 11B and 12, each rail 22 and 24 is positioned in a trim 57 along the sides of the aforementioned rear cargo space 15 in various arrangements. The rails 22 and 24 include projections 55 to position the rails 22 and 24 slightly away from the vertical side of the trim 57. This allows for the formation of an angled portion 54 in each of the rails 22 and 24. The angled portion 54 prevents binding of the crossbars 18 and 20 as they are moved from one position to another positon. The ends of the crossbars 18 and 20 include a cap 52 in particular arrangements that are sized to fit into the slots 50. A top portion 58 of the trim 57 prevents the ends of the crossbars 18 and 20 from inadvertently from popping out of the slots 50 in which the crossbars 18 and 20 are positioned.

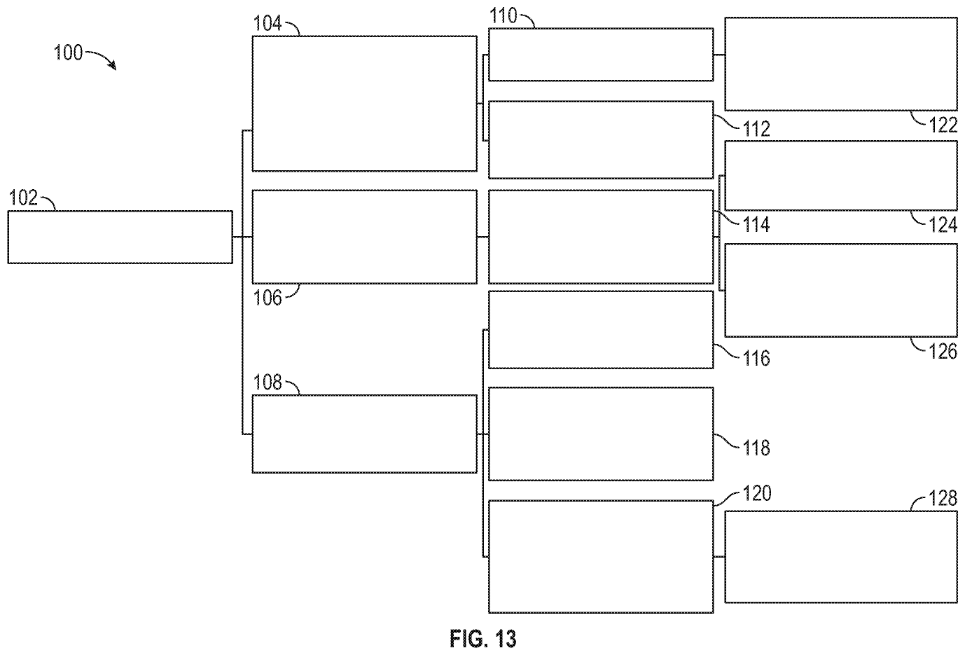

Referring now to FIG. 13, there is shown a process 100 for the use of the cargo sling and shelf 10. In step 102, a customer opens the rear cargo space 15. In step 104, the customer reaches in and pulls the first crossbar 18 to pull the mesh 16 toward him or her and locks the crossbar 18 rear most set of slots 50 in the rails 22 and 24 to create a taut load shelf. In step 110, the customer puts items on the load shelf and places large items, such as a cooler on the floor of the rear cargo space. In various arrangements, the shelf is capable of holding around 40 kg. In step 122, the customer utilizes tie downs or bungies to attach the items to the mesh 16.

After opening the rear cargo space 15, in some circumstances, the customer rolls up the mesh 16 around one of the crossbars 18 and 20 and locks the crossbar in a set of slots in the rails 22 and 24. In step 114, the customer creates a reduced load shelf and moves it closer to the customer if desired in step 114. In step 124, the customer places items on top of the shelf and places heavier items on the floor of the rear cargo space. In step 126, tie downs are utilized on the crossbars to lock the mesh 16 in place and to retain the items on the mesh 16.

In other circumstances, the customer positions one or both crossbars 18 and 20 in one of many sling positions in step 108. In step 116, the customer can hang items on hooks attached to one or both crossbars 18 and 20. In step 118, the customer places items, such as, for example, sport or outdoors equipment into the sling 32. Further, in step 120, the customer can position the first crossbar 18 in the lower mounting brackets to allow easier access to the sling 32. Such a region creates in step 128 an area to place and retain items like groceries and shopping bags.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A cargo sling and shelf for a vehicle comprising:
a first rail positioned in an interior of a rear cargo space of the motor vehicle, the first rail having a plurality of slots;
a second rail positioned on an opposite side of the interior of the rear cargo space, the second rail having a plurality of slots, the second rail being substantial parallel to the first rail;
a first crossbar having a first end that engages with one of the plurality of slots of the first rail and a second end that engages with one of the plurality of slots of the second rail;
a second crossbar having a first end that engages with one of the plurality of slots of the first rail and a second end that engages with one of the plurality of slots of the second rail; and
a mesh having a first side that is attached to the first crossbar and a second side that is attached to the second crossbar,
wherein the mesh forms a shelf between the first crossbar and the second crossbar.

2. The cargo sling and shelf of claim 1, wherein the mesh forms a sling between the first crossbar and the second crossbar.

3. The cargo sling and shelf of claim 1, wherein the mesh is partially rolled about the first crossbar or the second crossbar to form a reduced shelf.

4. The cargo sling and shelf of claim of claim 1, wherein the mesh includes one or more storage pockets.

5. The cargo sling and shelf of claim 4, wherein at least one of the storage pockets is a zippered storage pocket.

6. The cargo sling and shelf of claim 1, wherein the mesh includes raised edges to prevent items from rolling off the mesh.

7. The cargo sling and shelf of claim 6, wherein the edges are made of rubber.

8. The cargo sling and shelf of claim 1 further comprising a first mounting bracket positioned below the first rail in the interior of the rear cargo space and a second mounting bracket positioned below the second rail in the interior of the rear cargo space, the first end of the first crossbar engaging with the first mounting bracket and the second end of the first crossbar engaging with the second mounting bracket.

9. The cargo sling and shelf of claim 1, wherein the sling and shelf holds about 40 kg.

10. The cargo sling and shelf of claim 1, wherein the plurality of slots of the first rail is five slots and the plurality of slots of the second rail is five slots.

11. A method of forming a cargo sling and shelf in a motor vehicle, the method comprising:
positioning a first end of a first crossbar in one of a plurality of slots in a first rail and a second end the first crossbar in of one a plurality of slots in a second rail, the first rail being positioned in an interior of a rear cargo space of the motor vehicle; and
positioning a first end of a second crossbar in one of the plurality of slots in the first rail and a second end the second crossbar in of one the plurality of slots in the second rail, the second rail positioned on an opposite side of the interior of the rear cargo space, the second rail being substantial parallel to the first rail,
wherein a mesh having a first side is attached to the first crossbar and a second side that is attached to the second crossbar, the mesh forming a shelf between the first crossbar and the second crossbar.

12. The method of claim 11, wherein the mesh forms a sling between the first crossbar and the second crossbar.

13. The method of claim 11 further comprising partially rolling the mesh about the first crossbar or the second crossbar to form a reduced shelf.

14. The method of claim 11, wherein the mesh includes one or more storage pockets.

15. The method of claim 14, wherein at least one of the storage pockets is a zippered storage pocket.

16. The method of claim 11, wherein the mesh includes raised edges to prevent items from rolling off the mesh.

17. The method of claim 11 further comprising positioning the first end of the first crossbar in a first mounting bracket and the second end of the first crossbar in a second mounting bracket, the first mounting bracket being positioned below the first rail in the interior of the rear cargo space and the second mounting bracket being positioned below the second rail in the interior of the rear cargo space.

18. The method of claim 11, wherein the sling and shelf holds about 40 kg.

19. A cargo sling and shelf for a vehicle comprising:
a first rail positioned in an interior of a rear cargo space of the motor vehicle, the first rail having a plurality of slots;
a second rail positioned on an opposite side of the interior of the rear cargo space, the second rail having a plurality of slots, the second rail being substantial parallel to the first rail;
a first mounting bracket positioned below the first rail in the interior of the rear cargo space and a second mounting bracket positioned below the second rail in the interior of the rear cargo space;
a first crossbar having a first end that engages with one of the plurality of slots of the first rail or the first mounting bracket and a second end that engages with one of the plurality of slots of the second rail or the second mounting bracket;
a second crossbar having a first end that engages with one of the plurality of slots of the first rail and a second end that engages with one of the plurality of slots of the second rail; and
a mesh having a first side that is attached to the first crossbar and a second side that is attached to the second crossbar,
wherein the mesh forms a shelf or a sling between the first crossbar and the second crossbar.

20. The cargo sling and shelf of claim 19, wherein the mesh is partially rolled about the first crossbar or the second crossbar to form a reduced shelf.
